(19) United States
(12) Patent Application Publication
(10) Pub. No.: US 2006/0230243 A1
(43) Pub. Date: Oct. 12, 2006

(54) Cascaded snapshots

(76) Inventors: Robert Cochran, Sacramento, CA (US); Karl Dohm, Colorado Springs, CO (US); Matthias Popp, Roseville, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/099,767

(22) Filed: Apr. 6, 2005

(51) Int. Cl. G06F 12/16

(52) U.S. Cl. 711/162

(57) ABSTRACT

In one embodiment, a method comprises receiving a signal indicative of a request to create a child snapshot volume of a parent snapshot volume, and in response to the signal creating a data structure for the child snapshot volume, the data structure comprising a plurality of data fields to store data for a corresponding plurality of tracks in the volume; and populating the plurality of data fields with pointers to corresponding data fields in the parent snapshot volume.

### BACKGROUND

The described subject matter relates to electronic computing, and more particularly to cascaded snapshots.

Effective collection, management, and control of information have become a central component of modern business processes. To this end, many businesses, both large and small, now implement computer-based information management systems.

Data management is an important component of computer-based information management systems. Many users implement storage networks to manage data operations in computer-based information management systems. Storage networks have evolved in computing power and complexity to provide highly reliable, managed storage solutions that may be distributed across a wide geographic area.

### SUMMARY

In one embodiment, a method comprises receiving a signal indicative of a request to create a child snapshot volume of a parent snapshot volume, and in response to the signal creating a data structure for the child snapshot volume, the data structure comprising a plurality of data fields to store data for a corresponding plurality of tracks in the volume; and populating the plurality of data fields with pointers to corresponding data fields in the parent snapshot volume.

### BRIEF DESCRIPTION OF THE DRAWINGS

FIG. 1 is a schematic illustration of an exemplary embodiment of a networked computing system that utilizes a storage network.

FIG. 2 is a schematic illustration of an exemplary embodiment of a storage network.

FIG. 3 is a schematic illustration of an exemplary embodiment of an array controller.

FIG. 4 is a schematic illustration of an exemplary embodiment of a data architecture that may be implemented in a storage device.

FIG. 5 is a flowchart illustrating operations in a first embodiment of a method to generate a cascaded snapshot.

FIG. 6 is a schematic illustration of an exemplary embodiment of a data architecture that includes a cascaded snapshot.

FIG. 7 is a flowchart illustrating operations in a second embodiment of a method to generate a cascaded snapshot.

FIGS. 8a-8b are schematic illustrations of an exemplary embodiment of a data architecture that includes a cascaded snapshot.

FIG. 9 is a flowchart illustrating operations in an exemplary embodiment of a method to maintain a cascaded snapshot logical volume.

FIG. 10 is a flowchart illustrating operations in an exemplary embodiment of a method to restore a production volume.

FIG. 11 is a schematic illustration of an exemplary embodiment of a data architecture that includes a cascaded snapshot.

### DETAILED DESCRIPTION

Described herein are exemplary system and methods for implementing cascaded snapshots in a storage device, array, or network. The methods described herein may be embodied as logic instructions on a computer-readable medium. When executed on a processor such as, e.g., an array controller, the logic instructions cause the processor to be programmed as a special-purpose machine that implements the described methods. The processor, when configured by the logic instructions to execute the methods recited herein, constitutes structure for performing the described methods. The methods will be explained with reference to one or more logical volumes in a storage system, but the methods need not be limited to logical volumes.

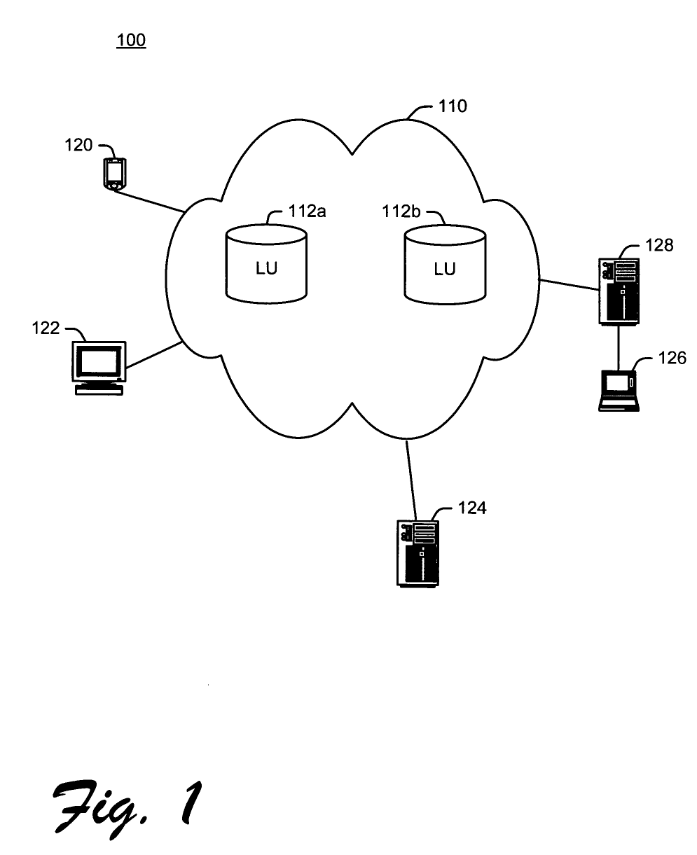

FIG. 1 is a schematic illustration of an exemplary embodiment of a networked computing system 100 that utilizes a storage network. The storage network comprises a storage pool 110, which comprises an arbitrarily large quantity of storage space. In practice, a storage pool 110 has a finite size limit determined by the particular hardware used to implement the storage pool 110. However, there are few theoretical limits to the storage space available in a storage pool 110.

A plurality of logical disks (also called logical units or LUs) 112a, 112b may be allocated within storage pool 110. Each LU 112a, 112b comprises a contiguous range of logical addresses that can be addressed by host devices 120, 122, 124 and 128 by mapping requests from the connection protocol used by the host device to the uniquely identified LU 112. As used herein, the term “host” comprises a computing system(s) that utilize storage on its own behalf, or on behalf of systems coupled to the host. For example, a host may be a supercomputer processing large databases or a transaction processing server maintaining transaction records. Alternatively, a host may be a file server on a local area network (LAN) or wide area network (WAN) that provides storage services for an enterprise. A file server may comprise one or more disk controllers and/or RAID controllers configured to manage multiple disk drives. A host connects to a storage network via a communication connection such as, e.g., a Fibre Channel (FC) connection.

A host such as server 128 may provide services to other computing or data processing systems or devices. For example, client computer 126 may access storage pool 110 via a host such as server 128. Server 128 may provide file services to client 126, and may provide other services such as transaction processing services, email services, etc. Hence, client device 126 may or may not directly use the storage consumed by host 128.

Devices such as wireless device 120, and computers 122, 124, which are also hosts, may logically couple directly to LUs 112a, 112b. Hosts 120-128 may couple to multiple LUs 112a, 112b, and LUs 112a, 112b may be shared among multiple hosts. Each of the devices shown in FIG. 1 may include memory, mass storage, and a degree of data processing capability sufficient to manage a network connection.

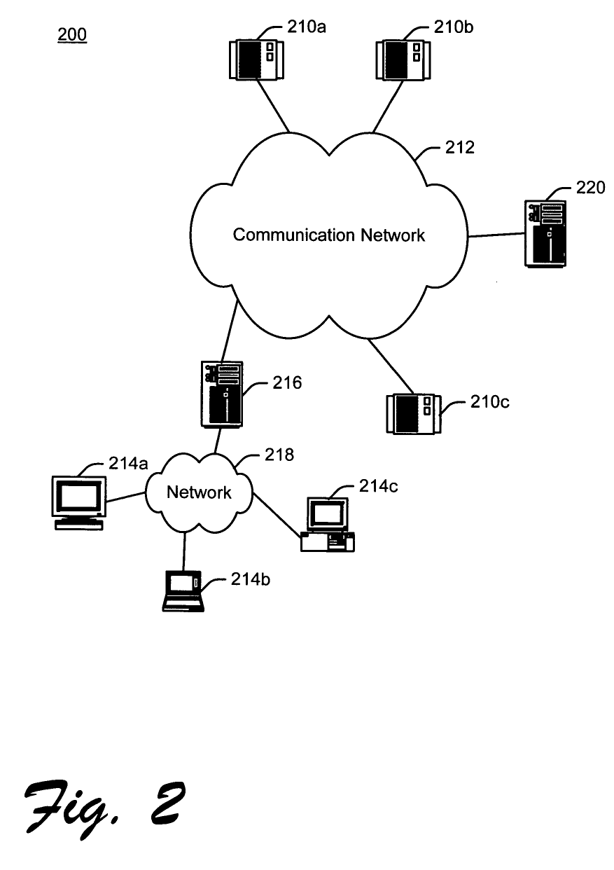

FIG. 2 is a schematic illustration of an exemplary storage network 200 that may be used to implement a storage pool such as storage pool 110. Storage network 200 comprises a plurality of storage cells 210a, 210b, 210c connected by a communication network 212. Storage cells 210a, 210b, 210c may be implemented as one or more communicatively connected storage devices. Exemplary storage devices include the STORAGEWORKS line of storage devices commercially available from Hewlett-Packard Corporation of Palo Alto, Calif., USA. Communication network 212 may be implemented as a private, dedicated network such as, e.g., a Fibre Channel (FC) switching fabric. Alternatively, portions of communication network 212 may be implemented using public communication networks pursuant to a suitable communication protocol such as, e.g., the Internet Small Computer Serial Interface (iSCSI) protocol.

Client computers 214a, 214b, 214c may access storage cells 210a, 210b, 210c through a host, such as servers 216, 220. Clients 214a, 214b, 214c may be connected to file server 216 directly, or via a network 218 such as a Local Area Network (LAN) or a Wide Area Network (WAN). The number of storage cells 210a, 210b, 210c that can be included in any storage network is limited primarily by the connectivity implemented in the communication network 212. A switching fabric comprising a single FC switch can interconnect 256 or more ports, providing a possibility of hundreds of storage cells 210a, 210b, 210c in a single storage network.

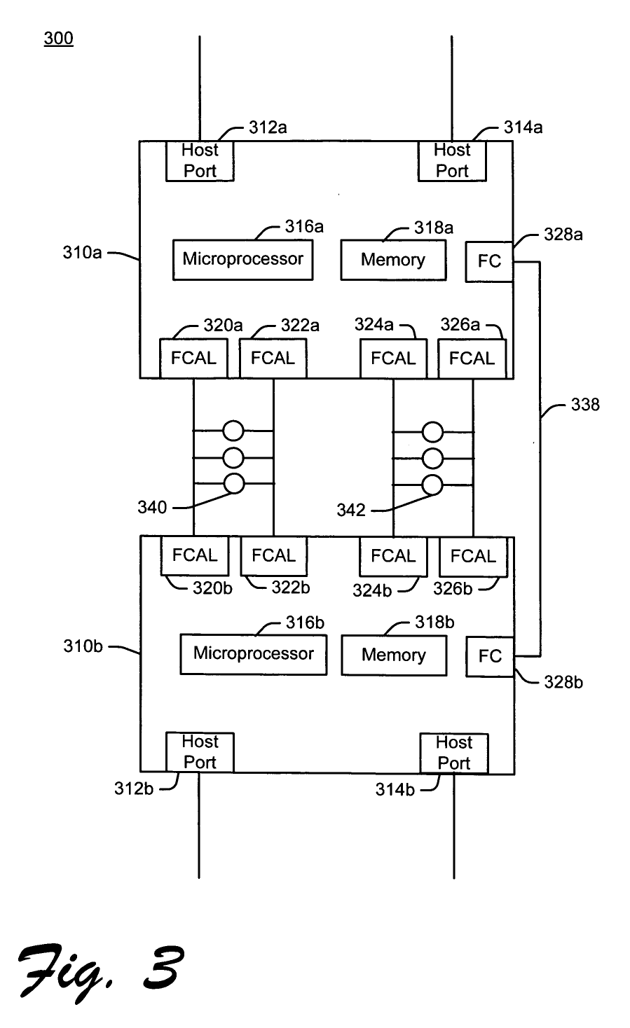

FIG. 3 is a schematic illustration of an exemplary embodiment of a storage cell 300. It will be appreciated that the storage cell 300 depicted in FIG. 3 is merely one exemplary embodiment, which is provided for purposes of explanation. The particular details of the storage cell 300 are not critical. Referring to FIG. 3, storage cell 300 includes two Network Storage Controllers (NSCs), also referred to as disk controllers, 310a, 310b to manage the operations and the transfer of data to and from one or more sets of disk drives 340, 342. NSCs 310a, 310b may be implemented as plug-in cards having a microprocessor 316a, 316b, and memory 318a, 318b. Each NSC 310a, 310b includes dual host adapter ports 312a, 314a, 312b, 314b that provide an interface to a host, i.e., through a communication network such as a switching fabric. In a Fibre Channel implementation, host adapter ports 312a, 312b, 314a, 314b may be implemented as FC N_Ports. Each host adapter port 312a, 312b, 314a, 314b manages the login and interface with a switching fabric, and is assigned a fabric-unique port ID in the login process. The architecture illustrated in FIG. 3 provides a fully-redundant storage cell. This redundancy is entirely optional; only a single NSC is required to implement a storage cell.

Each NSC 310a, 310b further includes a communication port 328a, 328b that enables a communication connection 338 between the NSCs 310a, 310b. The communication connection 338 may be implemented as a FC point-to-point connection, or pursuant to any other suitable communication protocol.

In an exemplary implementation, NSCs 310a, 310b further include a plurality of Fiber Channel Arbitrated Loop (FCAL) ports 320a-326a, 320b-326b that implements an FCAL communication connection with a plurality of storage devices, e.g., sets of disk drives 340, 342. While the illustrated embodiment implement FCAL connections with the sets of disk drives 340, 342, it will be understood that the communication connection with sets of disk drives 340, 342 may be implemented using other communication protocols. For example, rather than an FCAL configuration, a FC switching fabric may be used.

In operation, the storage capacity provided by the sets of disk drives 340, 342 may be added to the storage pool 110. When an application requires storage capacity, logic instructions on a host computer 128 establish a LU from storage capacity available on the sets of disk drives 340, 342 available in one or more storage sites. It will be appreciated that, because a LU is a logical unit, not a physical unit, the physical storage space that constitutes the LU may be distributed across multiple storage cells. Data for the application is stored on one or more LUs in the storage network. An application that needs to access the data queries a host computer, which retrieves the data from the LU and forwards the data to the application.

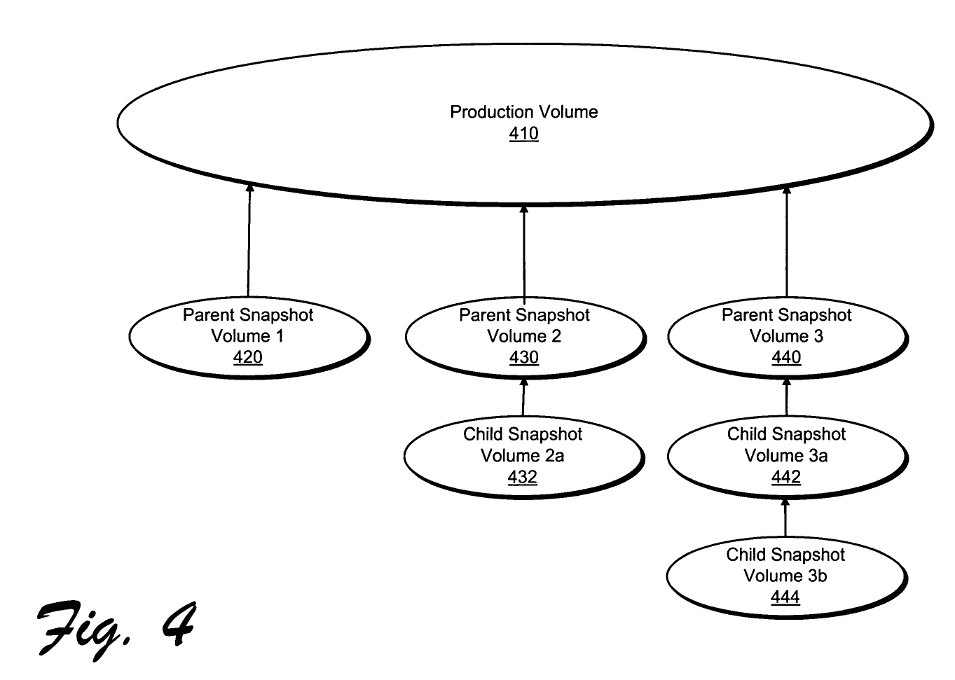

FIG. 4 is a schematic illustration of an exemplary embodiment of a data architecture that may be implemented in a storage device. Referring to FIG. 4, a production volume 410 of a storage volume such as, e.g., a LU, may include one or more snapshots, depicted in FIG. 4 as parent snapshot volume 1 420, parent snapshot volume 2 430, and parent snapshot volume 3 440. The respective parent snapshots 420, 430, and 440 may represent a point-in-time copy of the production volume 410 taken different points in time. While FIG. 4 represents three parent snapshot volumes it will be understood that in practice a greater number or a lesser number of snapshots may exist. Additionally, it will be appreciated that the snapshots may be both readable and writable.

The data architecture depicted in FIG. 4 further includes one or more cascaded snapshot volumes. Hence, one or more of the parent snapshot volumes 420, 430, 440 may have one or more snapshot volumes taken at points in time. For example, the data architecture illustrated in FIG. 4 includes a snapshot of parent snapshot volume 2 430, which is designated as child snapshot volume 2a 432. Similarly, the data architecture illustrated in FIG. 4 includes a snapshot of parent snapshot volume 3 440, which is designated as child snapshot volume 3a 442.

The data architecture depicted in FIG. 4 may include multiple levels of cascaded snapshots. Hence, one or more of the cascaded snapshot volumes 432, 442, may also have one or more snapshot volumes at points in time. For example, the data architecture illustrate in FIG. 4 includes a snapshot of child snapshot volume 442, which is designated as child snapshot volume 3b 444. There is no theoretical limit to the number of cascaded snapshots from a parent snapshot that may be implemented in FIG. 4. In practice, the number of cascades snapshots may be limited by constraints on memory, or hardware or software functionality.

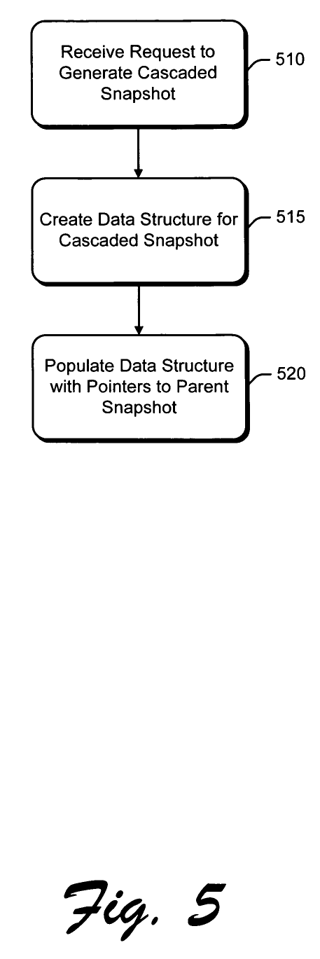

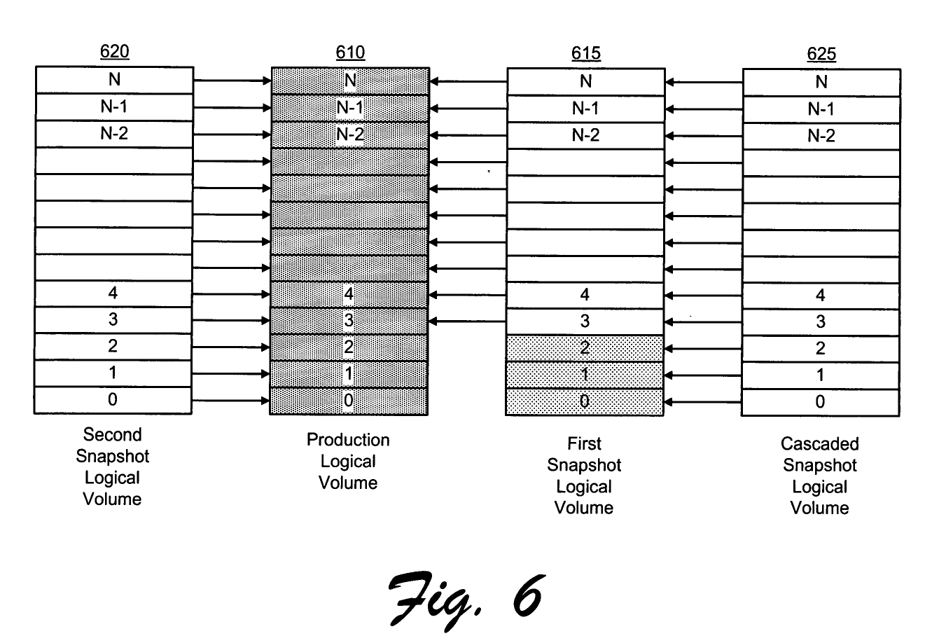

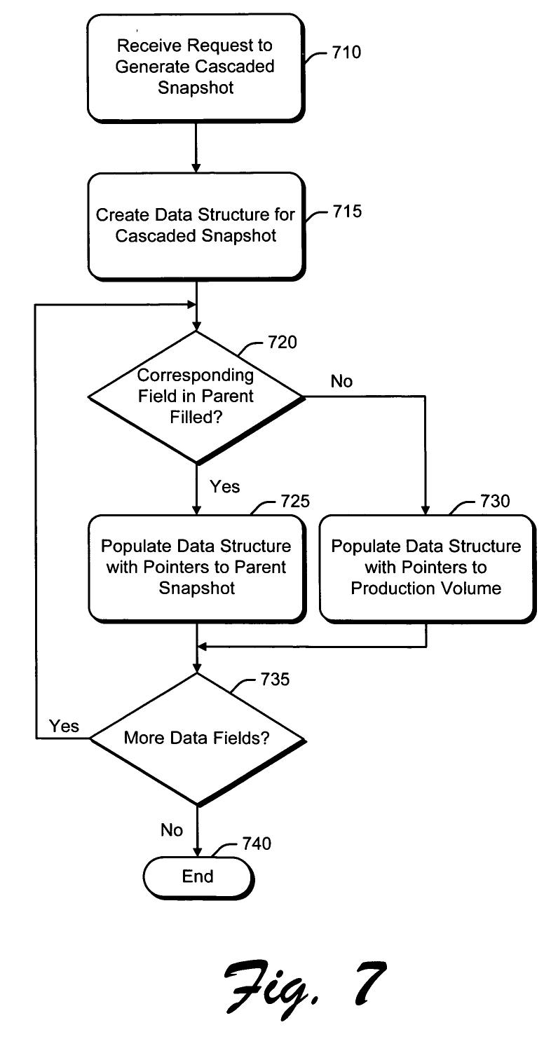

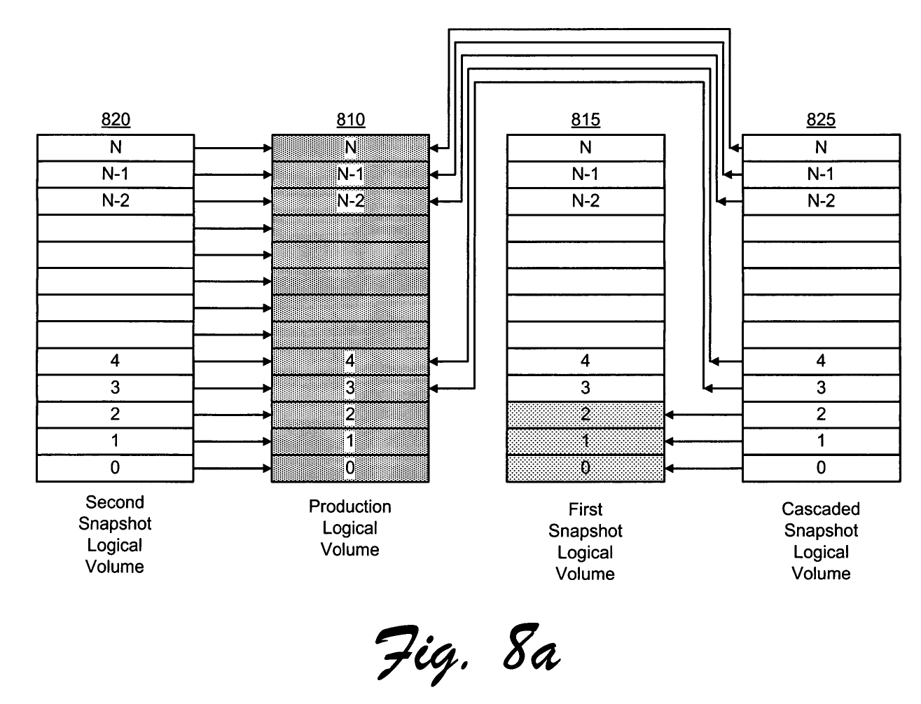

FIG. 5 is a flowchart illustrating operations in a first embodiment of a method to generate a cascaded snapshot. FIG. 6 is a schematic illustration of an exemplary embodiment of a data architecture that includes a cascaded snapshot. The operations illustrated in FIG. 5 may be used to implement a data architecture such as the data architecture depicted in FIG. 6. Referring to FIG. 5, at operation 510 a signal that indicates a request to generate a cascaded snapshot is received, for example, in an array controller. The request may have been generated by a user (e.g., an administrator) at a user interface or automatically by a software module that manages operations of a storage cell or an array controller.

In response to the signal, at operation 515 a data structure is created for the cascades snapshot. This may be illustrated with reference to FIG. 6. Referring to FIG. 6, there is illustrated a production logical volume 610 that includes a plurality of tracks, indicated sequentially as tracks 0, 1, 2 . . . N. Tracks 0, 1, 2 . . . N represent data fields. The shading of tracks 0, 1, 2 . . . N is intended to represent that the tracks 0, 1, 2 . . . N include data.

FIG. 6 further illustrates a first snapshot logical volume 615 that was created at a first point in time and a second snapshot logical volume 620 that was created at a second point in time. Referring first to the second snapshot logical volume 620, tracks 0, 1, 2 . . . N include pointers to the respective corresponding track in production logical volume 610. Similarly, referring first snapshot logical volume 615, tracks 3, 4 . . . N include pointers to the respective corresponding track in production logical volume. Tracks 0, 1, and 2 include data representing the data state of the respective corresponding tracks at the point in time when first snapshot logical volume 615 was created.

The differences between the data states of first snapshot logical volume 615 and second snapshot logical volume 620 may arise when the data in production volume 610 is changed after first snapshot logical volume 615 is created, but before second snapshot logical volume 620 is created. When data in a track(s) of the production logical volume 610 is changed, a processor such as, e.g., an array controller, may execute a command that contemporaneously copies the contents of the track(s) of the production logical volume 610 to the corresponding track(s) in the first snapshot logical volume 615. In addition, the pointer(s) from the affected track(s) in the first snapshot logical volume 615 may be removed. This “copy on write” procedure ensures that the first snapshot logical volume 615 preserves the data state of production logical volume 610 at the point in time when first snapshot logical volume 615 was created.

When operation 515 is executed, a processor such as, e.g., an array controller may generate a data structure for a cascaded snapshot logical volume 625. In one embodiment the cascaded snapshot logical volumes exist in a parent-child relationship. Hence, data structure 625 includes a plurality of tracks indicated sequentially as tracks 0, 1, 2 . . . N. At operation 520 each track in the data structure for cascaded snapshot logical volume 625 is populated with a pointer that points to the corresponding track in the parent snapshot logical volume 615. Thus, upon creation, cascaded snapshot logical volume 625 represents a point in time copy of the data state of first snapshot logical volume 615.

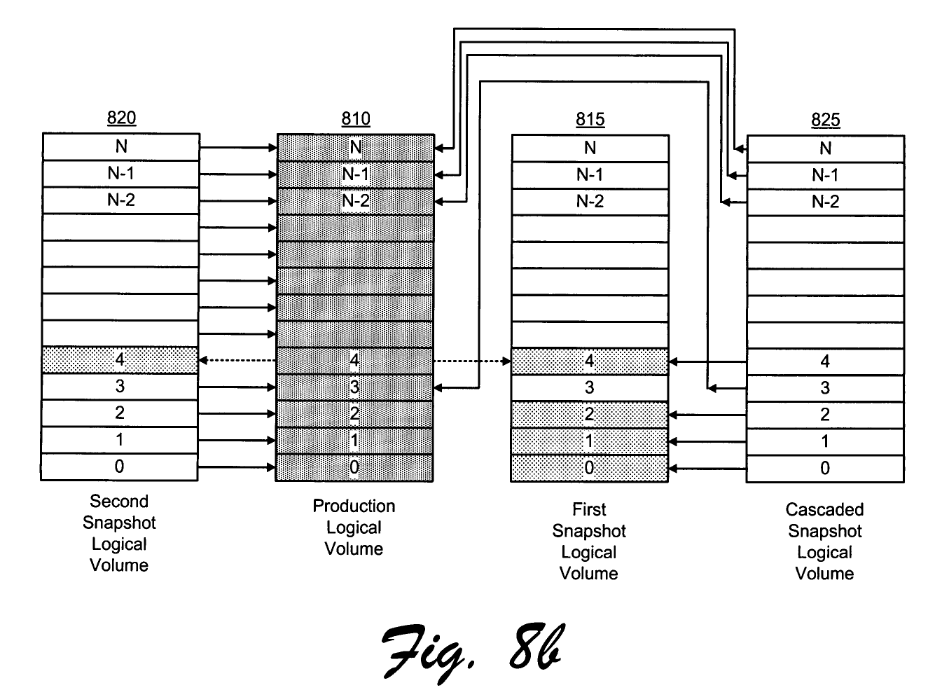

FIG. 7 is a flowchart illustrating operations in a second embodiment of a method to generate a cascaded snapshot. FIG. 8a is a schematic illustration of an exemplary embodiment of a data architecture that includes a cascaded snapshot. The operations illustrated in FIG. 7 may be used to implement a data architecture such as the data architecture depicted in FIG. 8a. Referring to FIG. 7, at operation 710 a signal that indicates a request to generate a cascaded snapshot is received, for example, in an array controller. The request may have been generated by a user (e.g., an administrator) at a user interface or automatically by a software module that manages operations of a storage cell or an array controller.

In response to the signal, at operation 715 a data structure is created for the cascaded snapshot. This may be illustrated with reference to FIG. 8a. Referring to FIG. 8a, the data structures depicted in FIG. 8a are substantially similar to the data structures depicted in FIG. 6. In the interest of clarity, redundant explanations of similar aspects of the data structures will be avoided. Specifically, pointers pertaining to tracks 3-N of 815 are not shown.

Operations 720-735 implement a loop to set the pointers in cascaded snapshot logical volume. The loop may begin with track 0 and increment upwardly through the tracks of cascaded logical volume 825. Alternatively, the loop may start with track N and decrement downwardly through the tracks of cascaded logical volume 825. Alternatively, any other suitable step function may be used to traverse the tracks of cascaded snapshot logical volume 825. In a logical volume the respective tracks may represent logical storage segments, and hence may not correspond directly to a track on a physical disk.

If at operation 720 the corresponding data field (i.e., track) in the parent snapshot logical volume is filled with data, rather than a pointer to another logical volume, then control passes to operation 725 and the pointer in the cascaded snapshot logical volume is pointed to the corresponding track in the parent snapshot logical volume. Referring to FIG. 8a, this is illustrated in tracks 0, 1, 2, the pointers of which are set to point to the corresponding track in the first snapshot logical volume 815.

By contrast, if at operation 720 the corresponding field (i.e., track) in the parent snapshot logical volume is not filled with data, then control passes to operation 730 and the pointer in the cascaded snapshot logical volume is pointed to the corresponding track in the production volume. Referring to FIG. 8a, this is illustrated in tracks 3, 4 . . . N, the pointers of which are set to point to the corresponding tracks in the production volume 810.

Operations 720-730 are repeated until, at operation 735, there are no more data fields in the cascaded snapshot logical volume 825 to process. Thus, upon instantiation, cascaded snapshot logical volume 825 represents a point in time copy of the data state of first snapshot logical volume 815.

In operation, the data in a production logical volume may change over time, e.g., as a result of I/O operations executed against the production logical volume. As described above with reference to FIG. 6, to preserve the data integrity of snapshot logical volumes, when an I/O operation affects the data in a track of a production logical volume a contemporaneous write operation is executed to write the original data in the track to the snapshot(s) of the production logical volume.

The data architecture depicted in FIG. 6 requires no active intervention to maintain the data integrity of the cascaded snapshot logical volume 625 when a change is made to the production logical volume. By contrast, when the production volume is changed in the data architecture depicted in FIG. 8a, the cascaded snapshot pointers need to be updated.

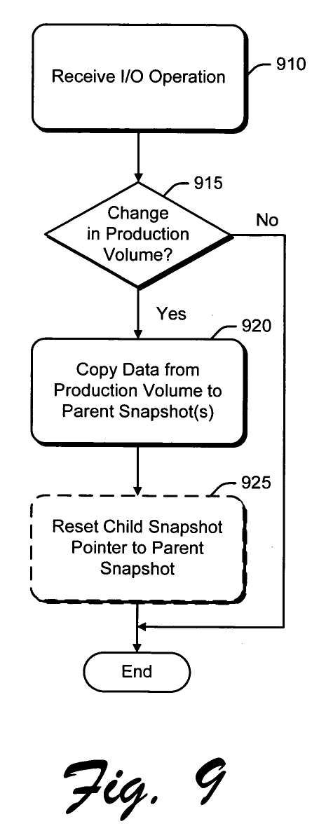

This is illustrated with reference to FIGS. 9 and 8b. FIG. 9 is a flowchart illustrating operations in an exemplary embodiment of a method to maintain a cascaded snapshot logical volume. FIG. 8b is a schematic illustration of the data architecture of FIG. 8a following a change to the data in the production logical volume. Referring to FIG. 9, at operation 910 an I/O operation on the production logical volume is received. If, at operation 915, the I/O operation changes the data in the production logical volume, then control passes to operation 920 and the data from the track(s) that will be affected by the I/O operation are copied to the corresponding track(s) of the parent snapshot(s) that include pointers to the affected track(s) in the production logical volume.

This may be illustrated in FIG. 8b with reference to track 4. An I/O operation that changes the data in track 4 of production logical volume 810 causes the data from track 4 of the production logical volume to be written to track 4 of the first snapshot logical volume 815 and the second snapshot logical volume 820. This may be implemented by executing a copy-on-write command. Referring back to FIG. 9, at operation 925 the pointer of the corresponding track in the child snapshot logical volume is reset to point to the corresponding track in the parent snapshot logical volume. Thus, referring to FIG. 8b, the pointer from track 4 of the cascaded snapshot 825 logical volume is redirected from track 4 of the production logical volume 810 (see FIG. 8a) to track 4 of the first snapshot logical volume 815, thereby maintaining data integrity in the cascaded snapshot logical volume 825.

Cascaded snapshots may be used in the process of restoring a production volume to a point in time. In one embodiment, in the event that a user wishes to restore a production volume using a selected snapshot volume, the user may have created a cascaded copy of the selected snapshot volume. The user may test the restore process using the cascaded snapshot volume, leaving the selected snapshot unaltered by testing. A production logical volume restore operation may be conducted using either the selected snapshot volume or the cascaded snapshot volume.

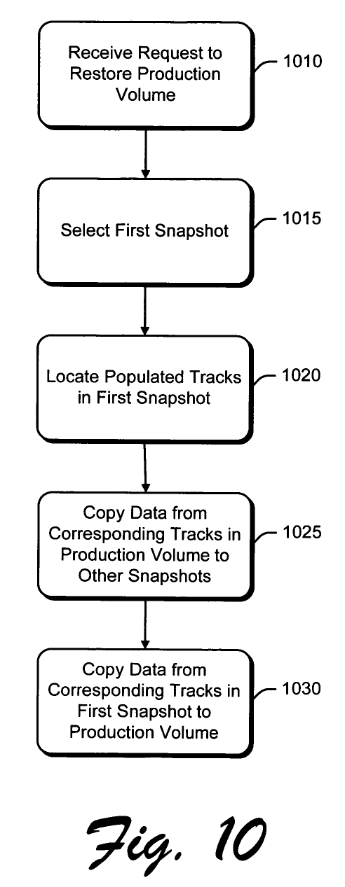

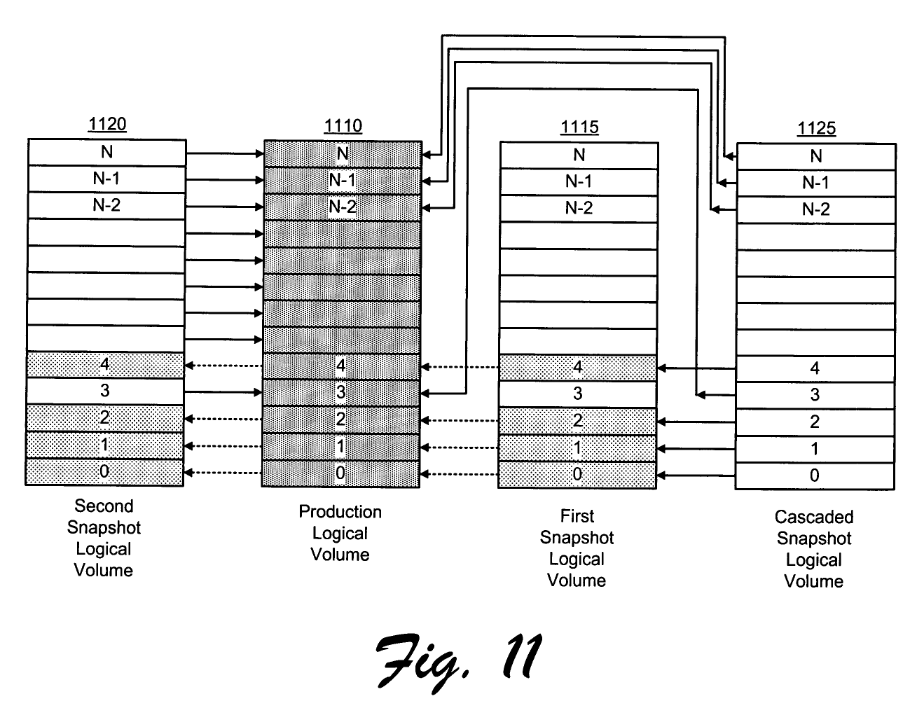

Exemplary restore operations will be explained with reference to FIGS. 10-11. FIG. 10 is a flowchart illustrating operations in an exemplary embodiment of a method to restore a production volume. FIG. 11 is a schematic illustration of an exemplary embodiment of a data architecture that includes a cascaded snapshot.

Referring to FIG. 10, at operation 1010 a request to restore a production volume to a previous data state is received at a processor such as, e.g., an array controller. In response to the request, at operation 1015 a first snapshot logical volume is selected as the source snapshot logical volume for use in restoring the production volume. At operation 1020 the processor locates one or more tracks in the first snapshot that are populated with data rather than pointers to another volume.

Referring to FIG. 11, a user such as, e.g., an administrator may select the first snapshot logical volume 1115 as the source snapshot for use in restoring the production logical volume 1110. Operation 1020 scans the first snapshot logical volume, in which tracks 0, 1, 2, and 4 are filled with data.

Referring back to FIG. 10, control then passes to operation 1025, in which data from the tracks in the production volume that correspond to the tracks identified in operation 1020 are copied to one or more other first or cascaded snapshots (i.e., snapshots other than the one selected in step 1015). In one embodiment the data is copied to all snapshots for which the data from the tracks in the production volume that correspond to the tracks identified in operation 1020 represents the point in time copy for the snapshot. Thus, in FIG. 11 tracks 0, 1, 2, and 4 are copied from the production logical volume 1110 to the corresponding track are of any first or cascaded snapshot for which a pointer to the same track in 1110 exists. In this specific case, tracks 0, 1, 2 and 4 are copied from the production volume 1110 to the second snapshot logical volume 1120, thereby maintaining the data integrity of second snapshot logical volume 1120.

Control then passes to operation 1030 and the populated data tracks in the first snapshot volume are copied to the production volume. Thus, in FIG. 11 tracks 0, 1, 2, and 4 are copied from the first snapshot logical volume 1115 to the production logical volume 1110, thereby restoring production logical volume 1110 to the point in time at which first snapshot logical volume 1115 was taken. Various pointers may have to be manipulated after the production volume is restored. For example, the pointers in logical volume 1125 that refer to logical volume 1115 may be redirected to production logical volume 1110.

Reference in the specification to “one embodiment” or “an embodiment” means that a particular feature, structure, or characteristic described in connection with the embodiment is included in at least an implementation. The appearances of the phrase “in one embodiment” in various places in the specification are not necessarily all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method, comprising:
receiving a signal indicative of a request to create a child snapshot volume of a parent snapshot volume;
in response to the signal:
creating a data structure for the child snapshot volume, the data structure comprising a plurality of data fields to store data for a corresponding plurality of tracks in the volume; and
populating the plurality of data fields with pointers to corresponding data fields in the parent snapshot volume.

2. The method of claim 1, wherein receiving a signal indicative of a request to create a child snapshot volume of a parent snapshot volume comprises receiving a signal from a user interface in a computing system.

3. The method of claim 1, wherein one or more corresponding data fields in the parent snapshot volume comprise pointers to corresponding data fields in a production volume.

4. The method of claim 1, wherein one or more corresponding data fields in the parent snapshot volume comprise data copied from a production volume.

5. A method, comprising:
receiving a signal indicative of a request to create a child snapshot volume of a parent snapshot volume;
in response to the signal:
creating a data structure for the child snapshot volume, the data structure comprising a plurality of data fields to store data for a corresponding plurality of tracks in the volume; and
populating the plurality of data fields with pointers to corresponding data fields in the parent snapshot volume when the corresponding data fields in the parent snapshot volume comprise data copied from a production volume; and
populating the plurality of data fields with pointers to the corresponding data field in a production volume when the corresponding data fields in the parent snapshot volume comprise pointers to the production volume.

6. The method of claim 5, wherein receiving a signal indicative of a request to create a child snapshot volume of a parent snapshot volume comprises receiving a signal from a user interface in a computing system.

7. The method of claim 5, further comprising:
receiving an I/O operation that changes data in a track of the production volume;
in response to the I/O operation:
copying the data in the track of the production volume to the parent snapshot volume before executing the I/O operation; and
setting a pointer associated with a corresponding track in the child snapshot volume to point to the corresponding data field in the parent snapshot volume.

8. A method, comprising:
receiving a request to restore a production volume to a previous data state;
in response to the request:
selecting a first parent snapshot volume;
locating one or more populated tracks in the first parent snapshot volume that include data copied from the production volume;
copying data from one or more corresponding tracks in the production volume to one or more corresponding tracks in a second parent snapshot volume; and
copying data from the one or more populated tracks in the first parent snapshot volume to one or more corresponding tracks in the production volume.

9. The method of claim 8, wherein selecting a first parent snapshot volume comprises:
creating a child snapshot volume of the first parent snapshot volume; and
testing a restore operation using the child snapshot volume.

10. The method of claim 9, wherein creating a child snapshot volume of the first parent snapshot volume comprises:
creating a data structure for the child snapshot volume, the data structure comprising a plurality of data fields to store data for a corresponding plurality of tracks in the volume; and
populating the plurality of data fields with pointers to corresponding data fields in the parent snapshot volume.

11. The method of claim 9, wherein creating a child snapshot volume of the first parent snapshot volume comprises:
creating a data structure for the child snapshot volume, the data structure comprising a plurality of data fields to store data for a corresponding plurality of tracks in the volume; and
populating the plurality of data fields with pointers to corresponding data fields in the parent snapshot volume when the corresponding data fields in the parent snapshot volume comprise data copied from a production volume; and
populating the plurality of data fields with pointers to the corresponding data field in a production volume when the corresponding data fields in the parent snapshot volume comprise pointers to the production volume.

12. A storage controller, comprising:
a first I/O port that provides an interface to a host computer;
a second I/O port that provides an interface a storage device;
a processor that receives I/O requests generated by the host computer and, in response to the I/O requests, generates and transmits I/O requests to the storage device; and
a memory module communicatively connected to the processor and comprising logic instructions which, when executed by the processor, configure the processor to:
receive a signal indicative of a request to create a child snapshot volume of a parent snapshot volume stored on the storage device; and
in response to the signal:
create a data structure for the child snapshot volume, the data structure comprising a plurality of data fields to store data for a corresponding plurality of tracks in the volume; and
populate the plurality of data fields with pointers to corresponding data fields in the parent snapshot volume.

13. The storage controller of claim 12, wherein one or more corresponding data fields in the parent snapshot volume comprise pointers to corresponding data fields in a production volume.

14. The storage controller of claim 12, wherein one or more corresponding data fields in the parent snapshot volume comprise data copied from a production volume.

15. A storage controller, comprising:
a first I/O port that provides an interface to a host computer;
a second I/O port that provides an interface a storage device;
a processor that receives I/O requests generated by the host computer and, in response to the I/O requests, generates and transmits I/O requests to the storage device; and
a memory module communicatively connected to the processor and comprising logic instructions which, when executed by the processor, configure the processor to:
receive a signal indicative of a request to create a child snapshot volume of a parent snapshot volume stored on the storage device; and
in response to the signal:
create a data structure for the child snapshot volume, the data structure comprising a plurality of data fields to store data for a corresponding plurality of tracks in the volume;
populate the plurality of data fields with pointers to corresponding data fields in the parent snapshot volume when the corresponding data fields in the parent snapshot volume comprise data copied from a production volume; and
populate the plurality of data fields with pointers to the corresponding data field in a production volume when the corresponding data fields in the parent snapshot volume comprise pointers to the production volume.

16. The storage controller of claim 15, further comprising logic instructions which, when executed by the processor, configure the processor to:
receive an I/O operation that changes data in a track of the production volume; and
in response to the I/O operation:
copy the data in the track of the production volume to the parent snapshot volume before executing the I/O operation; and
set a pointer associated with a corresponding track in the child snapshot volume to point to the corresponding data field in the parent snapshot volume.

17. A storage controller, comprising:
a first I/O port that provides an interface to a host computer;
a second I/O port that provides an interface a storage device;
a processor that receives I/O requests generated by the host computer and, in response to the I/O requests, generates and transmits I/O requests to the storage device; and
a memory module communicatively connected to the processor and comprising logic instructions which, when executed by the processor, configure the processor to:
receive a request to restore a production volume to a previous data state; and
in response to the request:
select a first parent snapshot volume;
locate one or more populated tracks in the first parent snapshot volume that include data copied from the production volume;
copy data from one or more corresponding tracks in the production volume to one or more corresponding tracks in a second parent snapshot volume; and
copy data from the one or more populated tracks in the first parent snapshot volume to one or more corresponding tracks in the production volume.

18. The storage controller of claim 17, further comprising logic instructions which, when executed by the processor, configure the processor to:
create a child snapshot volume of the first parent snapshot volume; and
test a restore operation using the child snapshot volume.

19. The storage controller of claim 18, further comprising logic instructions which, when executed by the processor, configure the processor to:
create a data structure for the child snapshot volume, the data structure comprising a plurality of data fields to store data for a corresponding plurality of tracks in the volume; and
populate the plurality of data fields with pointers to corresponding data fields in the parent snapshot volume.

20. The storage controller of claim 17, further comprising logic instructions which, when executed by the processor, configure the processor to:
create a data structure for the child snapshot volume, the data structure comprising a plurality of data fields to store data for a corresponding plurality of tracks in the volume; and
populate the plurality of data fields with pointers to corresponding data fields in the parent snapshot volume when the corresponding data fields in the parent snapshot volume comprise data copied from a production volume; and
populate the plurality of data fields with pointers to the corresponding data field in a production volume when the corresponding data fields in the parent snapshot volume comprise pointers to the production volume.
